(19) United States
(12) Patent Application Publication
(10) Pub. No.: US 2013/0050455 A1
(43) Pub. Date: Feb. 28, 2013

(54) ENDOSCOPE APPARATUS

(71) Applicant: Yukiyoshi YAGI, Sagamihara-shi (JP)

(72) Inventor: Yukiyoshi YAGI, Sagamihara-shi (JP)

(73) Assignee: OLYMPUS CORPORATION, Tokyo (JP)

(21) Appl. No.: 13/597,744

(22) Filed: Aug. 29, 2012

(30) Foreign Application Priority Data
Aug. 30, 2011 (JP) 2011-187837

(51) Int. Cl. H04N 7/18

(52) U.S. Cl. 348/65; 348/E07.085

(57) ABSTRACT

An endoscope apparatus includes: an endoscope body including an image processing circuit for processing a video signal outputted from an image pickup device provided at a distal end portion of an insertion portion; an image pickup device driving circuit provided for the endoscope body and providing a drive signal to the image pickup device via the insertion portion; and a control section having a first display form for displaying an endoscope image based on the video signal and a second display form for displaying an endoscope image with an image quality different from that of the first display form, and controlling the image pickup device driving circuit to change a charge accumulation period of the image pickup device, accompanying an operation of switching to the second display form during display in the first display form.

### CROSS REFERENCE TO RELATED APPLICATION

This application claims benefit of Japanese Application No. 2011-187837 filed in Japan on Aug. 30, 2011, the contents of which are incorporated by this reference.

### BACKGROUND OF THE INVENTION

1. Field of the Invention

The present invention relates to an endoscope apparatus which adopts a high-resolution image pickup device.

2. Description of the Related Art

Conventionally, endoscopes have been widely used which are elongated and are inserted into a body cavity or the like to observe a site to be examined or perform various treatments. In the industrial field also, industrial endoscopes are widely used with which a flaw, corrosion and the like inside a boiler, a turbine, an engine, a chemical plant and the like can be observed or examined.

An endoscope has an elongated insertion portion provided with a bending portion which can be bent by a hand-side operation, and a CCD or the like, which is an image pickup device, is provided at a distal end portion of the insertion portion. Image information obtained by the CCD is transmitted to an endoscope body connected at a user's hand side of the endoscope. The endoscope body generates a video signal based on the transmitted image information, and displays an endoscope image by providing the image signal to a display device.

For example, Japanese Patent Application Laid-Open Publication No. 2002-209837 discloses an electronic endoscope image pickup system which prevents a flicker of brightness by equalizing charge accumulation periods of the CCD among fields.

An endoscope apparatus provided with such an endoscope and endoscope body is provided with a light source apparatus to perform shooting inside a cavity. If a light emitting section of the light source apparatus is provided on the endoscope body side, illuminating light from the light emitting section is transmitted by a light guide or the like and lead to a distal end portion of the insertion portion of the endoscope to illuminate an object. A light emitting section, such as an LED, may be provided at the distal end portion of the insertion portion. In this case, power for driving the light emitting section is supplied from the endoscope body side.

### SUMMARY OF THE INVENTION

An endoscope apparatus according to an aspect of the present invention includes: an endoscope body including an image processing circuit for processing a video signal outputted from an image pickup device provided at a distal end portion of an insertion portion; an image pickup device driving circuit provided for the endoscope body and providing a drive signal to the image pickup device via the insertion portion; and a control section having a first display form for displaying an endoscope image based on the video signal and a second display form for displaying an endoscope image with an image quality different from that of the first display form, and controlling the image pickup device driving circuit to skip reading out in units of one field or one frame of the image pickup device to change a charge accumulation period, accompanying an operation of switching to the second display form during display in the first display form.

The above and other objects, features and advantages of the invention will become more clearly understood from the following description referring to the accompanying drawings.

### BRIEF DESCRIPTION OF THE DRAWINGS

FIG. 1A is a block diagram showing an endoscope apparatus according to a first embodiment of the present invention;

FIG. 1B is a block diagram showing a specific configuration of an image pickup device driving circuit 23 and a driver section 24 in FIG. 1A;

FIG. 2 is an explanatory diagram for illustrating a CCD 50 which is an example of an image pickup device adopted by an image pickup unit 14 in FIG. 1A;

FIG. 3 is a timing chart for illustrating a reading-out operation of the CCD 50 at the time of live display in a live operation mode;

FIG. 4 is a waveform chart showing an area surrounded by a circle in FIG. 3, being enlarged;

FIG. 5 is an explanatory diagram for illustrating an operation of a whole image pickup apparatus at the time of the live display;

FIG. 6 is a timing chart for illustrating a reading-out operation of the CCD 50 at the time of still image shooting in the live operation mode;

FIG. 7 is an explanatory diagram for illustrating an operation of the whole image pickup apparatus in the live operation mode;

FIGS. 8A to 8C are explanatory diagrams for illustrating operations of the first embodiment;

FIG. 9 is a block diagram showing a second embodiment of the present invention;

FIGS. 10A and 10B are explanatory diagrams showing examples of a pattern table stored in a memory 64;

FIGS. 11A and 11B are explanatory diagrams showing examples of the pattern table stored in the memory 64;

FIGS. 12A and 12B are explanatory diagrams showing examples of the pattern table stored in the memory 64;

FIG. 13 is a flowchart for illustrating an operation of the second embodiment;

FIG. 14 is a block diagram showing a third embodiment of the present invention;

FIG. 15 is an explanatory diagram showing an example of a pattern table stored in a memory 74 in FIG. 14;

FIG. 16 is a block diagram showing a fourth embodiment of the present invention;

FIG. 17 is an explanatory diagram for illustrating an operation of pre-freeze processing in the fourth embodiment; and

FIG. 18 is a flowchart for illustrating an operation of the fourth embodiment.

### DETAILED DESCRIPTION OF THE PREFERRED EMBODIMENTS

Embodiments of the present invention will be described below in detail with reference to drawings.

### First Embodiment

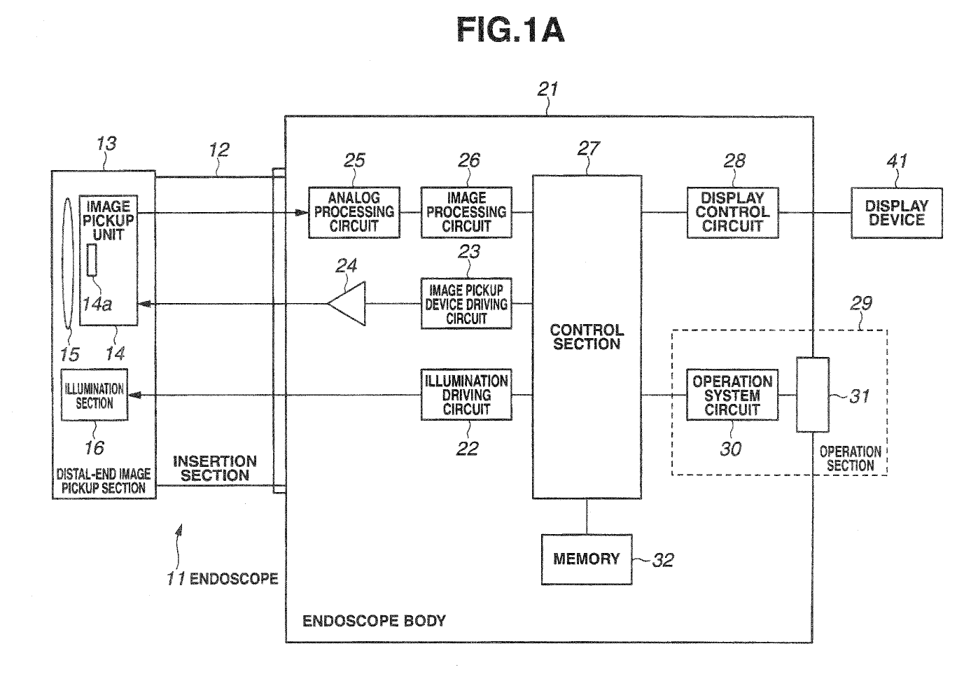

FIG. 1A is a block diagram showing an endoscope apparatus according to a first embodiment of the present invention.

The endoscope apparatus is configured by an endoscope 11 and an endoscope body 21. The endoscope 11 has an elongated insertion portion 12 which can be inserted into a tube cavity and the like, and a distal-end image pickup section 13 is arranged at a distal end of the insertion portion 12. A proximal end side of the insertion portion 12 of the endoscope 11 is detachably connected with the endoscope body 21 via a connector.

The distal-end image pickup section 13 is implemented with an image pickup unit 14 for picking up video of an object in a tube cavity or the like, an optical lens 15, and an illumination section 16. The image pickup unit 14 is provided with an image pickup device 14a.

The illumination section 16 has a light source such as an LED and is driven by an illumination driving circuit 22 to be described later so that it can radiate illuminating light onto an object. The optical lens 15 causes optical feedback from the object to enter an image pickup surface of the image pickup device 14a in the image pickup unit 14. The image pickup device 14a performs photoelectric conversion of an incident optical image of the object and sequentially outputs such outputs that are based on accumulated charge.

The insertion portion 12 includes a necessary number of signal lines for transmitting output from the image pickup device 14a of the distal-end image pickup section 13 and various control signal lines and power lines (hereinafter, simply referred to as signal lines), and control signal lines and power lines for illumination (hereinafter, simply referred to as illumination signal lines). Output from the image pickup device 14a is supplied to the endoscope body 21 via a signal line in the insertion portion 12.

Output from the image pickup device 14a is provided for an analog processing circuit 25 of the endoscope body 21. The analog processing circuit 25 is controlled by a control section 27 to perform predetermined analog video signal processing, such as amplification processing, for the output from the image pickup device 14a and then output the output to an image processing circuit 26. The image processing circuit 26 is controlled by the control section 27 to convert the output of the analog processing circuit 25 to a digital signal and then perform various image signal processes such as gamma correction processing, light adjustment processing, white balance adjustment processing and matrix processing. A video signal obtained by the image processing circuit 26 performing the image processes is provided for a display control circuit 28.

The display control circuit 28 is controlled by the control section 27 to provide the inputted video signal for a display device 41 and perform processing for displaying an endoscope image. The display device 41 configured by an LCD or the like is controlled by the display control circuit 28 to display the endoscope image.

The endoscope body 21 is provided with an image pickup device driving circuit 23 for driving the image pickup device 14a. The image pickup device driving circuit 23 is controlled by the control section 27 to generate various drive signals for driving the image pickup device 14a in the image pickup unit 14. The various drive signals from the image pickup device driving circuit 23 are amplified by a driver section 24 and transmitted to the image pickup device 14a in the image pickup unit 14 via a signal line in the insertion portion 12.

FIG. 1B is a block diagram showing an example of a specific configuration of the image pickup device driving circuit 23 and the driver section 24 in FIG. 1A. The image pickup device driving circuit 23 is configured by a drive control section 23a and a reading-out control section 23b. The drive control section 23a is controlled by the control section 27 to generate various drive signals for driving the image pickup device 14a. In FIG. 1B, only four drive signals, a reading-out pulse, a vertical synchronization signal, a horizontal synchronization signal and a reset gate signal, are shown to simplify description. These drive signals are provided for the image pickup device 14a by each of drivers 24a and 24b of the driver section 24.

The drivers 24a and 24b amplify the inputted drive signals and output the drive signals to the image pickup device 14a. In the present embodiment, the driver 24b is configured to be controlled by the reading-out control section 23b to be able to stop (skip) output of a reading-out pulse.

The reading-out control section 23b is adapted to be given a freeze signal indicating a freeze timing, from the control section 27, and generate a reading-out skipping control signal for skipping a reading-out pulse, in accordance with the freeze signal and a drive timing specified by the drive control section 23a.

The endoscope body 21 is provided with the illumination driving circuit 22 for driving the illumination section 16. The illumination driving circuit 22 is controlled by the control section 27 to generate various drive signals and drive voltage for driving the illumination section 16 in the image pickup unit 14. Output from the image pickup device driving circuit 23 is provided for the illumination section 16 via an illumination signal line in the insertion portion 12.

The endoscope body 21 is provided with an operation section 29. The operation section 29 is provided with an operation system circuit 30 and various operation switches 31. An operation signal is provided for the control section 27 from the operation system circuit 30 based on a user operation of the various operation switches 31. The operation switches 31 include various switches for controlling the endoscope body 21, for example, a shutter button, moving image recording start and end buttons and the like.

A memory 32 stores various information required for control by the control section 27. The control section 27 acquires information required for control, from the memory 32 based on an operation signal from the operation section 29 and controls each section. For example, when an operation button for giving an instruction to perform still image pickup is pressed by a user, the control section 27 outputs a freeze signal for giving an instruction to perform image pickup control to the image processing circuit 26 based on an operation signal from the operation system circuit 30. At the same time, the control section 27 specifies an image pickup timing to the analog processing circuit 25 and the image processing circuit 26 to cause the image processing circuit 26 to perform preset image processing of a picked-up image, and causes the display control circuit 28 to output an obtained endoscope image to the display device 41.

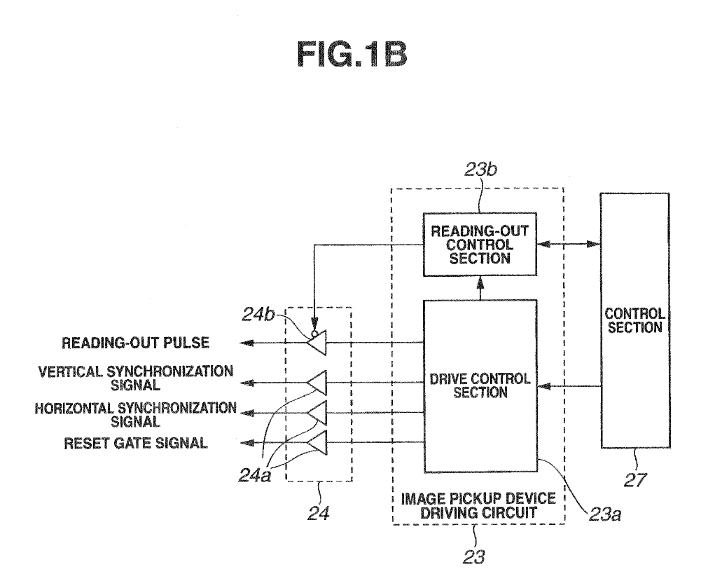

Next, a CCD 50, which is an example of the image pickup device 14a adopted by the image pickup unit 14, will be described with reference to an explanatory diagram of FIG. 2. FIG. 2 shows a configuration of a general CCD, and the image pickup device driving circuit 23 generates power supply voltage VDD and various control signals and provides them to the CCD 50. For example, a 1.25 megapixel CCD for high resolution can be adopted as the CCD 50. The CCD 50 in FIG. 2 shows an example of 4×4=16 pixels being configured within a light receiving area 51 for simplification of the drawing.

Each of 4×4 rectangular frames in the light receiving area 51 indicates a light receiving area 52 of each pixel. Vertical CCDs 54 (shaded parts) are provided along each column of the light receiving areas 52. In a horizontal direction, horizontal CCDs 55 (shaded parts) are provided.

The power supply voltage VDD, a vertical synchronization signal, a horizontal synchronization signal, a reset gate signal, an electronic shutter signal, a reading-out pulse and other control signals are provided for the CCD 50 from the image pickup device driving circuit 23. As for each of the light receiving areas 52 of the CCD 50, unnecessary charge is discarded therefrom by a reading-out pulse. Then, the light receiving area 52 is reset on a one-frame cycle, and it generates and accumulates charge based on light from an object. In the CCD 50, signal charge accumulated in each light receiving area 52 is transferred to a corresponding vertical CCD 54 by a reading-out pulse. Four-phase controlled vertical synchronization signals Vφ1 to Vφ4 provided from the image pickup device driving circuit 23 are applied to electrodes 53 of lines arranged extendedly in a horizontal direction. By the vertical synchronization signals Vφ1 to Vφ4, signal charge transferred to the vertical CCDs 54 is sequentially transferred to the horizontal CCDs 55 side. Signal charge corresponding to one line which has been transferred to the horizontal CCDs 55 is sequentially transferred in a horizontal direction by a horizontal synchronization signal Hφ. The signal charge transferred by the horizontal CCDs 55 is outputted from the output terminal Vout to the analog processing circuit 25 of the endoscope body 21 by a driver 54 as video signal output while signal charge corresponding to one pixel is reset by a reset gate signal φRG.

### (Live Display in Live Operation Mode)

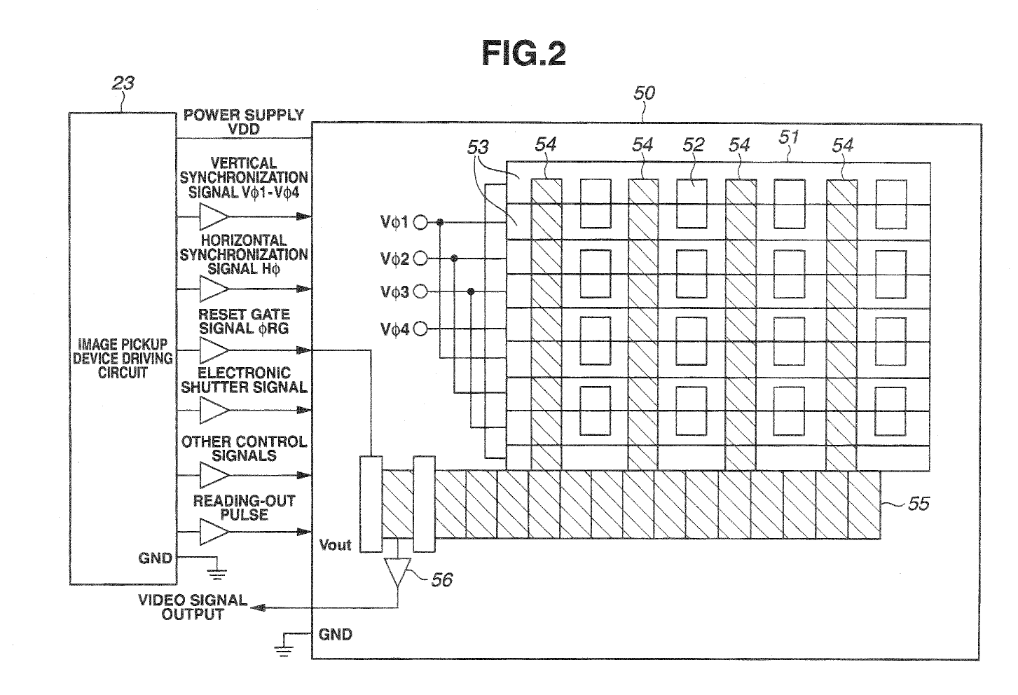

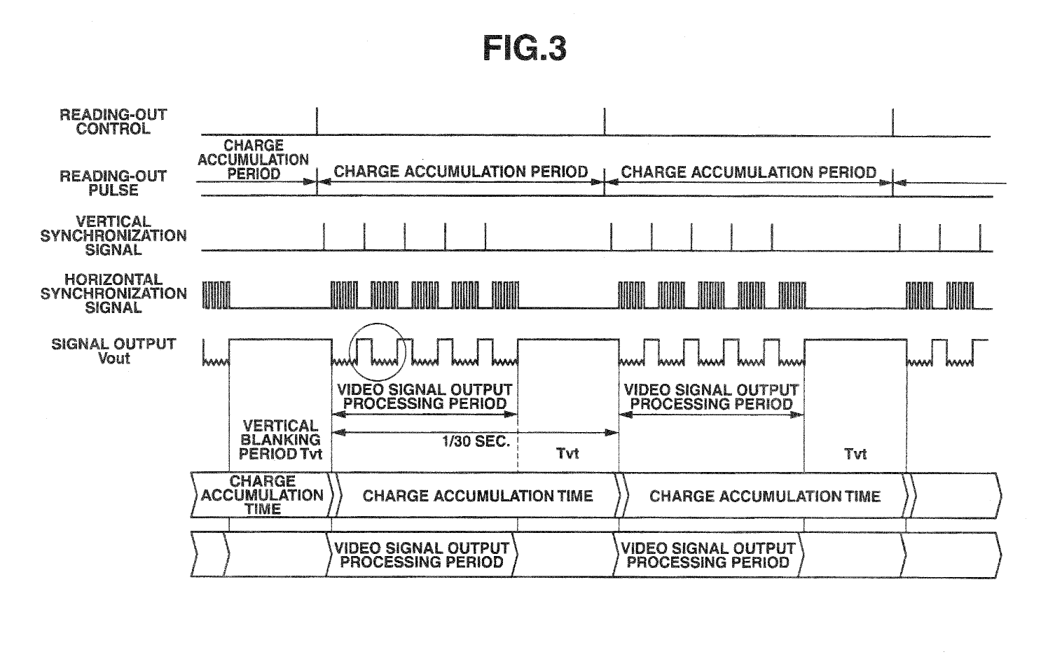

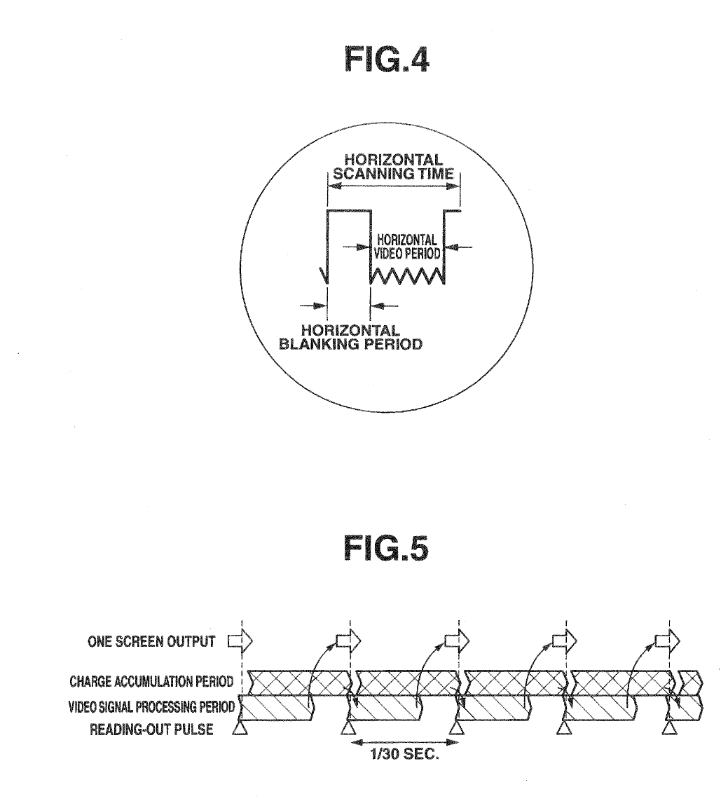

FIG. 3 is an example of a timing chart for illustrating a reading-out operation of the CCD 50 at the time of live display in a live operation mode; FIG. 4 is a waveform chart showing an area surrounded by a circle in FIG. 3, being enlarged; and FIG. 5 is an explanatory diagram for illustrating an operation of a whole image pickup apparatus at the time of live display.

As shown in FIG. 3, in the CCD 50, a period specified by a reading-out pulse is a charge accumulation period of the light receiving area 52. The amount of accumulated charge in the light receiving area 52 increases according to the amount of incident light. The image pickup device driving circuit 23 generates a reading-out pulse at an interval of a one-frame period to start reading out of signal charge accumulated in the light receiving area 52. The signal charge read out from the light receiving areas 52 of all pixels is transferred to corresponding vertical CCDs 54 and sequentially transferred to the horizontal CCDs 55 in synchronization with a vertical synchronization signal. Signal charge corresponding to one line which has been transferred to the horizontal CCDs 55 is sequentially transferred by a horizontal synchronization signal and outputted from the Vout terminal.

As shown in FIG. 4, signal charge of pixels corresponding to one line is transferred during a horizontal video period except a horizontal blanking period within one horizontal scanning period specified by a horizontal synchronization signal. Signal charge of respective pixels corresponding to one screen is transferred during a video signal output processing period except a vertical blanking period within a one-frame period of, for example, 1/30 seconds specified by a reading-out pulse.

FIG. 5 shows a flow of processing for every one-frame period (for example, 1/30 seconds) when a horizontal direction indicates time. In FIG. 5, cross hatching indicates a charge accumulation period, and oblique-line hatching indicates a video signal processing period. In FIG. 5, a triangle mark indicates a reading-out pulse, and an arrow indicates output of one screen from the endoscope body 21.

Signal charge accumulated during a charge accumulation period of each frame is read out by a reading-out pulse, transferred, provided for the endoscope body 21 and signal-processed during a next video signal processing period. Video signals sequentially outputted from the CCD 50 during a video signal output processing period are sequentially video-processed at the endoscope body 21, and the video signal output processing period and the video signal processing period are almost the same period. Then, the video signals signal-processed during the video signal processing period are provided for the display device 41 in a next frame and screen-displayed.

That is, at the time of live display in the live operation mode, (1) reading out from the CCD, (2) video signal processing/charge accumulation and (3) output of a live screen are repeated for every one frame. As described above, live video can be obtained by successively processing video signals which are cyclically outputted from the CCD.

### (Still Image Shooting in Live Operation Mode)

In the present embodiment, the image pickup device driving circuit 23 is adapted to be controlled by the control section 27 to thin out reading-out pulses given to the image pickup device 14a of the image pickup unit 14 such as the CCD 50 or the like, at the time of still image shooting in the live operation mode. For example, by controlling the driver 24b by a reading-out skipping control signal from the reading-out control section 23b in FIG. 1B, output of a reading-out pulse to the image pickup device 14a is skipped.

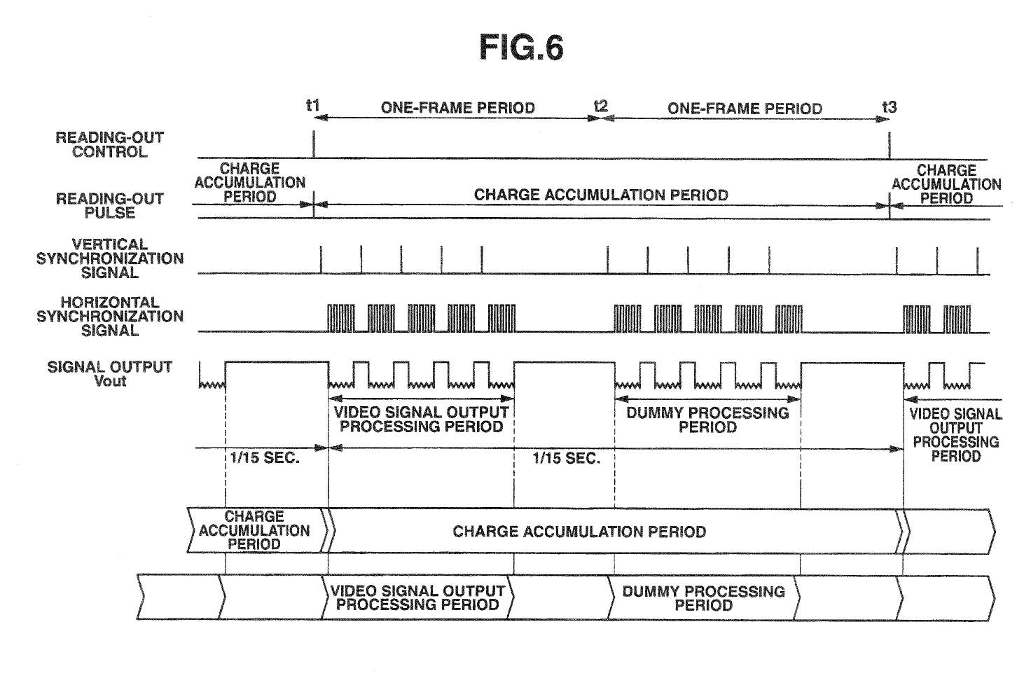

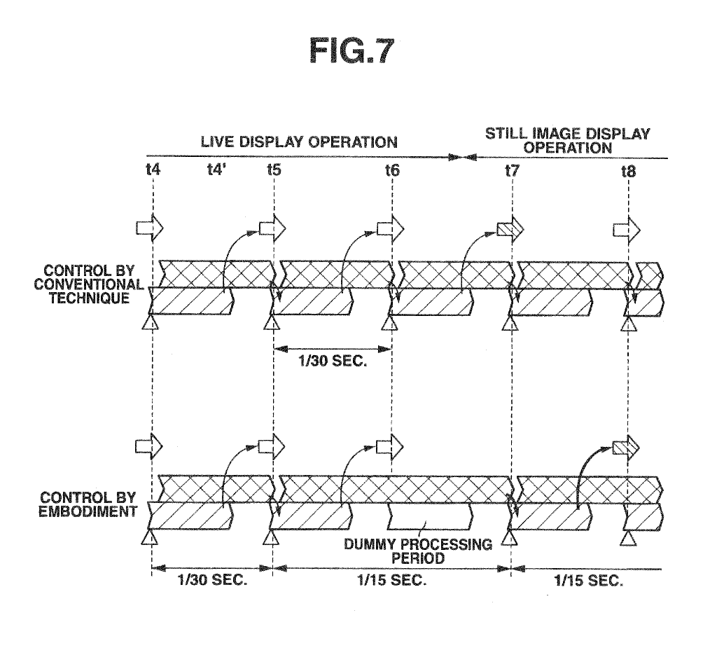

FIG. 6 is a timing chart for illustrating such a reading-out operation of the CCD 50 at the time of still image shooting in the live operation mode. FIG. 7 is an explanatory diagram for illustrating an operation of the whole image pickup apparatus in the live operation mode. In FIGS. 6 and 7, ways of illustration similar to those in FIGS. 3 and 5 are adopted, respectively.

In an example in FIG. 6 also, a one-frame period is 1/30 seconds similarly to the example in FIG. 3. In the example in FIG. 6, the image pickup device driving circuit 23 outputs reading-out pulses thinning out every other reading-out pulse, at the time of still image shooting. That is, a reading-out pulse cycle is 1/15 seconds. In this case, a reading-out pulse is generated on a 1/15 second cycle, and the charge accumulation period of the CCD 50 is 1/15 seconds.

In the present embodiment, other various control signals from the image pickup device driving circuit 23 are similar to those in FIG. 3. By a reading-out pulse from the image pickup device driving circuit 23, reading out of signal charge accumulated in the light receiving areas 52 is started during a charge accumulation period. The signal charge read out from the light receiving areas 52 of all pixels is transferred to corresponding vertical CCDs 54 and sequentially transferred to the horizontal CCDs 55 in synchronization with a vertical synchronization signal. Signal charge corresponding to one line which has been transferred to the horizontal CCDs 55 is sequentially transferred by a horizontal synchronization signal and outputted from the Vout terminal.

By a reading-out pulse generated at a timing t1 in FIG. 6, a charge accumulation period is started. At the time of live display, a reading-out pulse is generated at a timing t2 a one-frame period after the timing t1 (see FIG. 3). In comparison, at the time of still image shooting, the generation of a reading-out pulse at the timing t2 is omitted. However, since horizontal and vertical synchronization signals have been inputted, the CCD 50 performs signal charge transfer processing by the horizontal and vertical synchronization signals when the time t2 comes. In this case, reading out from the light receiving areas 52 by a reading-out pulse is not performed, and transfer of signal charge accumulated during a one-frame period from the timing t1 is not performed. In this way, a dummy processing period corresponding to a video signal output processing period is started at the timing t2. Accumulated charge is not transferred during the dummy processing period. Signal processing at the endoscope body 21 is not performed for an actual video signal, and the signal processing is dummy processing for a dummy video signal.

When a timing t3 comes, charge accumulated during a charge accumulation period of two frames between the timings t1 to t3 is read out in accordance with a reading-out pulse, and transferred and outputted by the vertical CCDs 54 and the horizontal CCDs 55. In this way, in the example in FIG. 6, output of the signal charge accumulated during the charge accumulation period of a two-frame period starts at an interval of a two-frame period.

At the time of still image display, since the charge accumulation period is extended to a two-frame period, a sufficient amount of charge is accumulated in the light receiving areas 52. Thereby, even in the case of a relatively small amount of illuminating light and the like, a video signal at a sufficient level can be obtained, and a higher image quality is possible. Though dark current noise which occurs in the CCD is almost constant irrespective of the length of the charge accumulation period, signal components increase in proportion to the length of the charge accumulation period. Therefore, at the time of still image display, S/N can be improved by extending the charge accumulation period.

FIG. 7 shows a flow of processing for every one-frame period (for example, 1/30 seconds) when a horizontal direction indicates time. In FIG. 7, an arrow without hatching indicates screen output in live display, and a hatched arrow indicates screen output in still image display.

At the time of still image shooting also, similarly to the time of live display, signal charge accumulated during a charge accumulation period of each frame is read out by a reading-out pulse, transferred, provided for the endoscope body 21 and signal-processed during a next video signal processing period. That is, in this case also, (1) reading out from the CCD, (2) video signal processing/charge accumulation and (3) output of a live screen are repeated.

FIG. 7 shows an example of a case where live display operation is performed at a timing t4, and a still image shutter button is operated at a timing t4′. Under control of a conventional technique shown in an upper part of FIG. 7, processing similar to that performed during the live display operation is repeated even after transition to still image display operation. That is, signal charge accumulated during a one-frame period starting from a timing t5 is transferred, outputted and video-signal-processed during a video signal processing period starting from a timing t6 and screen-outputted at a timing t7.

On the other hand, under control of the present embodiment shown in a lower part of FIG. 7, when live display operation transitions to still image display operation, reading-out pulses are thinned out. Thereby, a charge accumulation period starting from the time t5 is a two-frame period. During a dummy processing period starting from the timing t6, transfer, output and video signal processing are performed for a dummy video signal, and dummy video output is outputted (not shown).

Signal charge accumulated during the two-frame period from the timing t5 to the timing t7 is transferred, outputted and video-signal-processed during a video signal processing period starting from the timing t7 and screen-outputted at a timing t8.

The examples in FIGS. 6 and 7 show that very other reading-out pulse is omitted (skipped). It is, however, apparent that the frequency of the omission can be appropriately set.

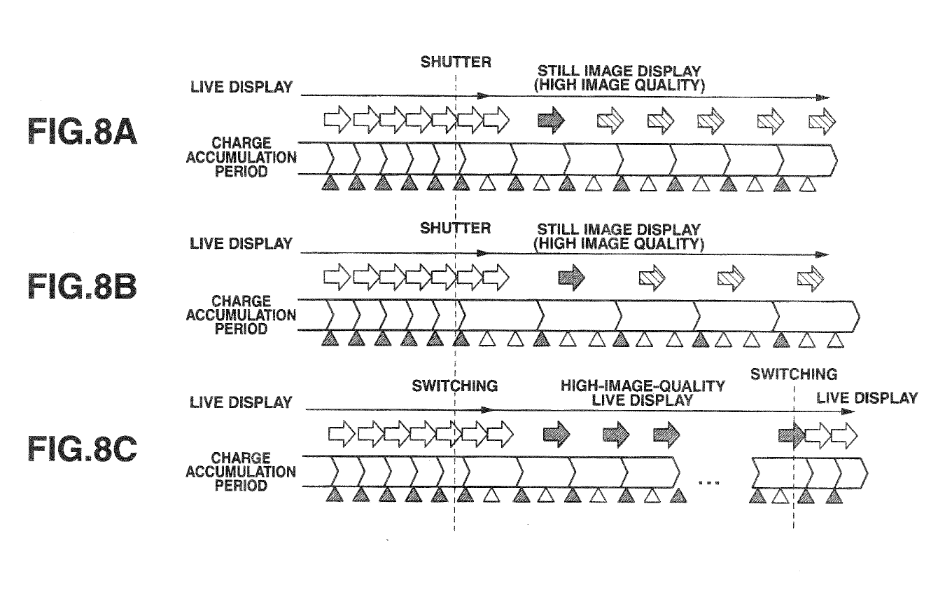

Next, operations of the embodiment configured as described above will be described with reference to FIGS. 8A to 8C. FIGS. 8A to 8C are explanatory diagrams for illustrating operations of the first embodiment. In FIGS. 8A to 8C, a filled triangle mark indicates a generated reading-out pulse and a white triangle mark indicates an omitted (skipped) reading-out pulse. An arrow indicates a screen output. A shaded arrow indicates screen output based on a video signal from the image pickup device 14a, and an arrow with oblique-line hatching indicates screen output based on a video signal stored in the memory.

In the present embodiment, in the live operation mode, (1) reading out from the CCD, (2) video signal processing/charge accumulation and (3) output of a live screen are repeated for every one-frame period, as shown in FIGS. 5 and 7. In this case, at the time of live display, a reading-out pulse is provided for the image pickup device 14a in the image pickup unit 14 on a one-frame cycle as shown in FIG. 5. In comparison, at the time of still image display, generation of a reading-out pulse is omitted, for example, every other time, and a reading-out pulse is provided for the image pickup device 14a in the image pickup unit 14 on a two-frame cycle as shown in FIG. 7.

Thereby, it is possible to extend charge accumulation time of the image pickup device 14a, and the amount of charge accumulation can be increased in comparison with the time of live display. For example, if generation of a reading-out pulse is omitted (skipped) every other time at the time of still image display, the charge accumulation period can be extended twice as long as that at the time of live display. If generation of a reading-out pulse is omitted (skipped) twice every three times, and a reading-out pulse is provided for the image pickup device 14a on a three-frame cycle, the charge accumulation period can be extended three times as long as that at the time of live display. By appropriately setting the number of reading-pulse omissions (the number of skips), the charge accumulation period can be extended an integral multiple times as long as that at the time of live display.

FIG. 8A shows an example of skipping every other reading-out pulse. At the time of live display, a reading-out pulse is generated on a one-frame cycle. When the user presses the shutter button in the state, a reading-out pulse is generated on a two-frame cycle, and the live display transitions to high-image-quality still image display. In the example in FIG. 8A, in still image display, the control section 27 causes a video signal from the image pickup device 14a to be stored into the memory 32 after performing image processing of the video signal. After that, in the still display mode, a still image is read from the memory 32 and screen-outputted.

As described above, in the example in FIG. 8A, a still image stored in the memory 32 is read and screen-outputted in the still image display mode. After a video signal obtained during a charge accumulation period, which is twice as long as that at the time of live display, is acquired only once, the cycle of generation of a reading-out pulse may be returned to a one-frame cycle.

It is also possible to, after still image is continued for a predetermined period, automatically return the still image display to live display. Alternatively, still image display may be returned to live display in accordance with a user operation for transition to live display.

FIG. 8B shows an example of skipping a reading-out pulse twice every three times. In this case, the charge accumulation period can be three times as long as that at the time of live display. Other operations are similar to the case of FIG. 8A.

In the examples in FIGS. 8A and 8B, even in the case of performing still image display, reading out from the image pickup device 14a is continued in a state that the charge accumulation period is two or three times as long as that at the time of live display. Therefore, moving image display (high-image-quality live display) is possible which uses a vide signal read from the image pickup device 14a in a state that the charge accumulation period is extended.

FIG. 8C shows an example of this case, and it shows that the user has performed a switching operation for transitioning to the high-image-quality live display. Thereby, in the example in FIG. 8C, a reading-out pulse is skipped once every two times and is generated on a two-frame cycle, so that moving image display is performed in the high-image-quality live display. That is, at the time of the high-image-quality live display, signal charge accumulated during a two-frame period is transferred, outputted, signal-processed and screen-outputted on a two-frame cycle. Thereby, though the frame rate becomes 1/2, moving image display at a high image quality is possible.

In FIG. 8C shows an example of returning to normal live display by the user performing a switching operation for returning to the normal live display to generate a reading-out pulse on a one-frame cycle.

As described above, in the present embodiment, when a user operation for still image display is performed during live display being performed, generation of a reading-out pulse for controlling reading out from the image pickup device is omitted an appropriate number of times. Thereby, it is possible to cause the charge accumulation period at the time of still image display to be an integral multiple as long as that at the time of live display, accumulate a sufficient amount of charge in the light receiving areas, improve S/N and realize a higher image quality. Especially, even when there is a relatively small amount of illuminating light by a lighting device or when a high-resolution image pickup device is adopted, it is possible to secure a charge accumulation period required for obtaining a sufficient image quality and improve the image quality. For example, even when a sufficient amount of illuminating light is not secured in an endoscope with a long insertion portion and a small insertion diameter, it is possible to accumulate a sufficient amount of charge in the light receiving area of each pixel and improve still image quality and live image quality.

### Second Embodiment

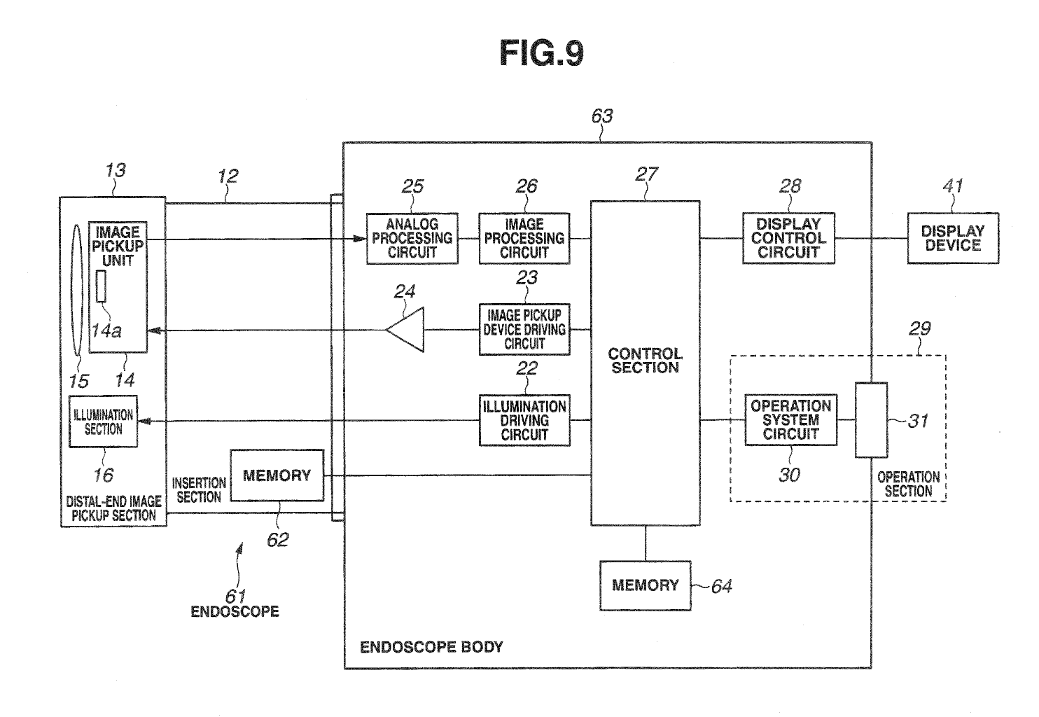

FIG. 9 is a block diagram showing a second embodiment of the present invention. In FIG. 9, the same components as FIG. 1A are given the same reference numerals, and description thereof is omitted. An endoscope 61 and an endoscope body 63 in the present embodiment are different from the endoscope 11 and the endoscope body 21 in FIG. A1 in that the endoscope 61 and the endoscope body 63 are provided with a memory 62 and a memory 64, respectively.

In the first embodiment, after a reading-out pulse is generated once, a reading-out pulse is omitted once or multiple times before a next reading-out pulse is generated. The number of reading pulse omissions (hereinafter referred to as the number of skips) is set in advance in the first embodiment. As the number of skips is larger, the charge accumulation period is longer, and sufficient charge can be accumulated in light receiving areas relative to the amount of incident light. Thereby, it is possible to improve S/N and realize higher image quality. However, in the case of a relatively large amount of illuminating light and the like, if the charge accumulation period is too long, charge accumulated in the light receiving areas overflows. In the case where the size of the light receiving areas is relatively large, it is conceivable that, if the charge accumulation period is too long, the level of signal charge becomes too high. That is, an optimum charge accumulation period differs according to the amount of illuminating light, the size of the light receiving areas, an object and the like.

Therefore, in the present embodiment, a table for determining an optimum charge accumulation period is prepared. If a user operation for still image, high-image-quality live display or the like is performed in the live display mode, the number of skips is set in accordance with the table, and thereby, it is possible to display an optimum endoscope image.

FIG. 9 shows an example in which the endoscope 61 has the memory 62 for holding endoscope information, and the endoscope body 63 is provided with the memory 64 for storing pattern tables. If only one type of endoscope exists as endoscopes connected to the endoscope body, the memory 62 can be omitted.

In the memory 62, for example, information such as the type of image pickup device (recorded as an ID number), the type of illuminating light, and the length and diameter of an illuminating light signal line are associated with an endoscope and recorded as endoscope information. On the other hand, the memory 64 on the endoscope body 63 side stores information similar to the information stored in the memory 32 in FIG. 1A as well as information about the number of skips for setting an optimum charge accumulation period corresponding to each endoscope information as a pattern table. For example, the memory 64 stores a pattern table in which, for each endoscope, and, for each information such as an image pickup device included in the endoscope, the type of illumination connected to the endoscope (distal-end illumination/body-side illumination), the length and diameter of an illumination signal line/illumination light guide, a corresponding number of skips are set.

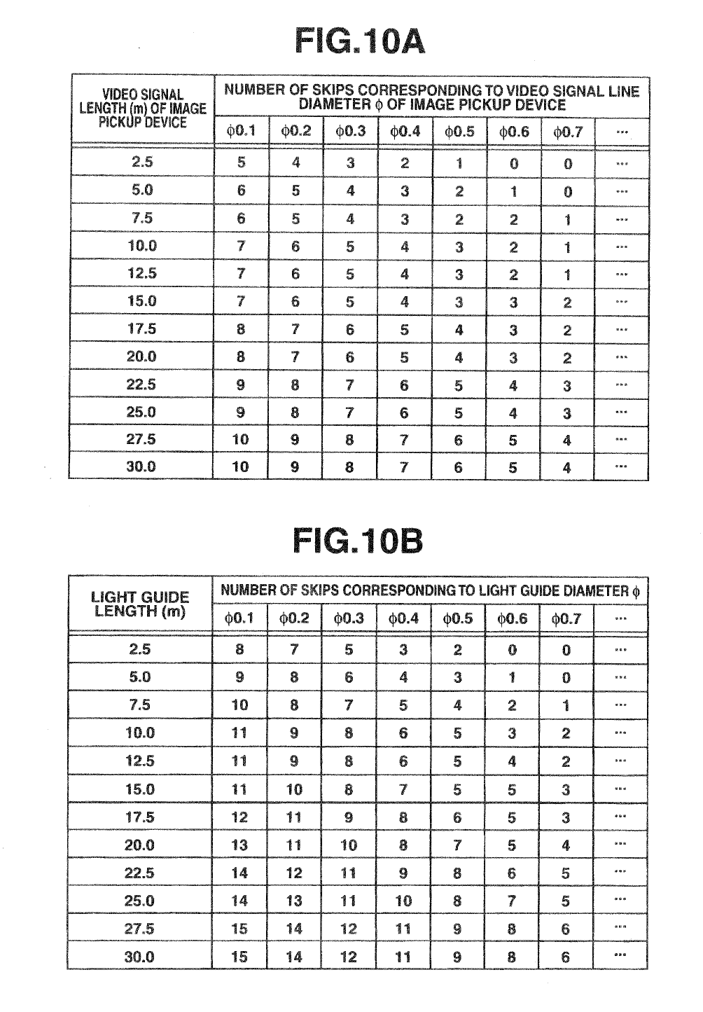

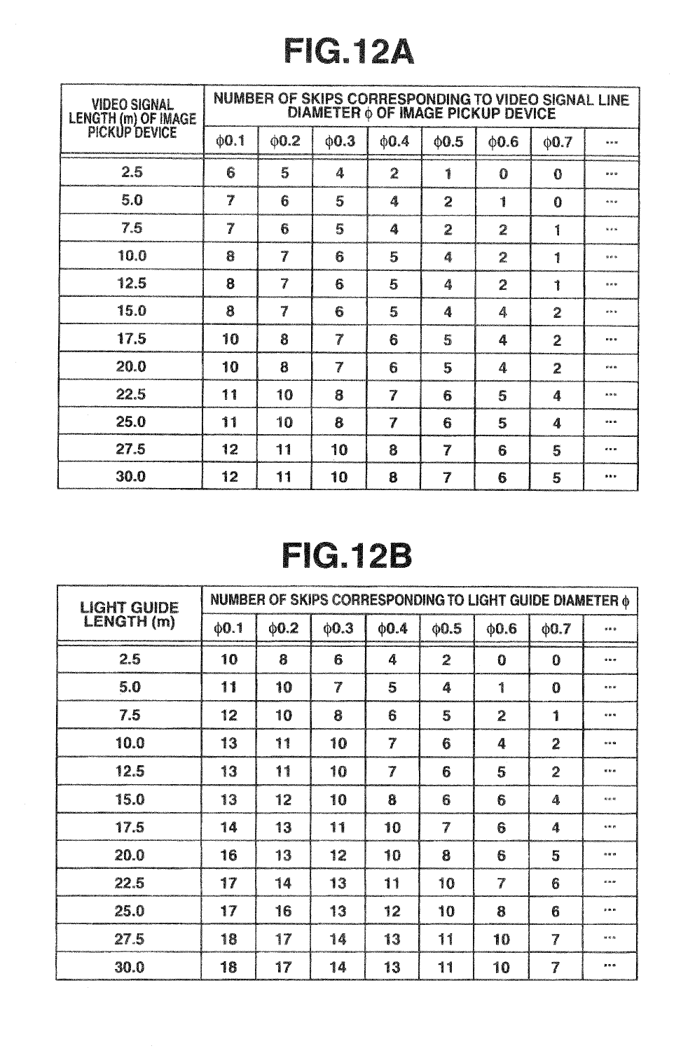

FIGS. 10A and 10B to FIGS. 12A and 12B are explanatory diagrams showing examples of such a pattern table stored in the memory 64. Pattern tables in FIGS. 10A and 10B to FIGS. 12A and 12B show an example in which, for each resolution of an image pickup device, the number of skips corresponding to information related to the amount of illuminating light is stored. FIGS. 10A and 10B to FIGS. 12A and 12B show pattern tables related to three image pickup devices (whose IDs are #1, #2 and #3) with different resolutions, respectively. FIGS. 10A, 11A and 12A show examples in which, as the type of illuminating light, such distal-end illumination that an illumination section 16, such as an LED, is provided at a distal-end image pickup section 13 is adopted as in FIG. 9. As for the endoscope, body-side illumination in which illuminating light is guided to the distal-end image pickup section by a light guide can be adopted. FIGS. 10B, 11B and 12B show pattern tables in the case of adopting such a body-side illumination.

The examples in FIGS. 10A, 11A and 12A show that a pattern table is provided for each image pickup device, and, in each pattern table, the number of skips corresponding to a video signal line diameter φ of the image pickup device is set for each video signal length (m) of the image pickup device. FIGS. 10B, 11B and 12B show that a pattern table is provided for each image pickup device, and, in each pattern table, the number of skips corresponding to a light guide diameter φ is set for each light guide length (m).

By reading out endoscope information from the memory 62, selecting a pattern table corresponding to the endoscope information from pattern tables stored in the memory 64 and referring to the selected pattern table, a control section 27 reads out the number of skips corresponding to the endoscope information. The control section 27 sets the read-out number of skips for an image pickup device driving circuit 23. The image pickup device driving circuit 23 is adapted to control generation of a reading-out pulse based on the number of skips set by the control section 27 to provide a reading-out pulse for an image pickup device 14a in an image pickup unit 14, omitting generation of a reading-out pulse the number of times corresponding to the number of skips.

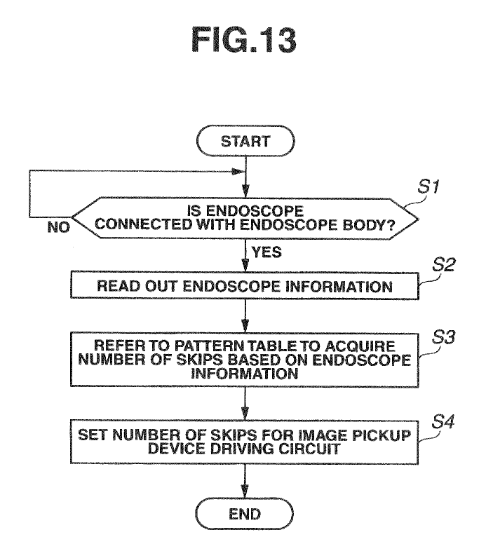

Next, an operation of the embodiment configured as described above will be described with reference to FIG. 13. FIG. 13 is a flowchart for illustrating the operation of the second embodiment.

In the endoscope body 63, various endoscopes are detachably configured. The control section 27 of the endoscope body 63 monitors a connection state of the endoscopes (step S1). When an endoscope is connected, the control section 27 performs reading out from a memory in the endoscope if reading out from the memory is possible. When the endoscope 61 in FIG. 9 is connected with the endoscope body 63, the control section 27 reads endoscope information from the memory 62 (step S2).

As the endoscope information, information such as the type of illuminating light, signal line length and signal line diameter for a control signal of the illuminating light, light guide length and light guide diameter for transmitting the illuminating light and the type of image pickup device (image pickup device ID) is stored. The control section 27 refers to a pattern table stored in the memory 64 of the endoscope body 63 to acquire the number of skips corresponding to the endoscope information (step S3). For example, the control section 27 selects a pattern table corresponding to the image pickup device ID, and refers to the selected pattern table to read out the number of skips corresponding to a corresponding signal line length, signal line diameter and the like.

The control section 27 sets the acquired number of skips for the image pickup device driving circuit 23 (step S4). After that, the image pickup device driving circuit 23 performs processing for skipping transmission of a reading-out pulse the number of times corresponding to the set number of skips.

Other operations are similar to those of the first embodiment. Because provision of a reading-out pulse to the image pickup device is skipped, the charge accumulation period at the time of still image display or the like is (the number of skips+1) times as long as the charge accumulation period at the time of live display. The number of skips corresponds to the amount of illuminating light. Therefore, even in the case of a small amount of illuminating light at the time of still image display and the like, it is possible to accumulate a sufficient and optimum amount of charge in the light receiving area of each pixel.

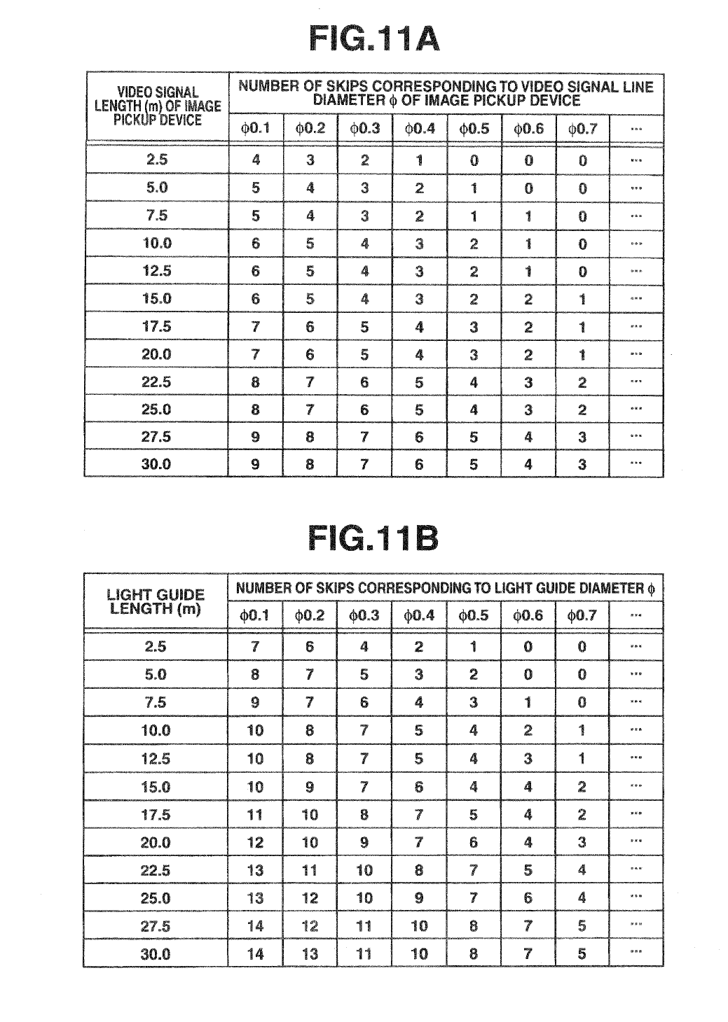

If a value from endoscope information read out from the memory 62 is different from a value in the pattern tables in FIGS. 10A and 10B and FIGS. 11A and 11B, the control section 27 may acquire the number of skips assigned to a value closest to the value from the endoscope information, from a pattern table.

As described above, in the present embodiment, since the number of skips corresponding to an optimum charge accumulation period for illuminating light is set, it is possible to always set an optimum charge accumulation period and realize higher image quality irrespective of the amount of illuminating light of an endoscope.

In the present embodiment, an example of setting the number of skips based on the type of image pickup device, the line length and diameter of a signal line or the light guide length and transmission diameter for obtaining illuminating light. However, if only one type of image pickup device is used, a pattern table based only on the line length and diameter of a signal line or the light guide length and transmission diameter for obtaining illuminating light may be prepared to set the number of skips. If transmission of illuminating light is performed by only one type of transmission line, a pattern table based only on the type of image pickup device may be prepared to set the number of skips.

### Third Embodiment

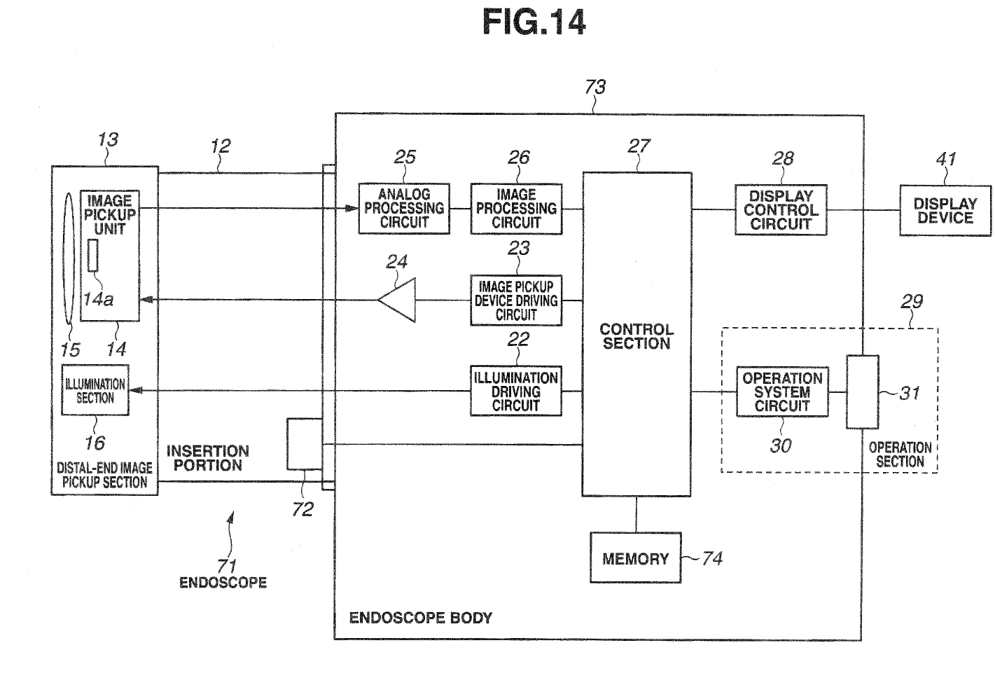

FIG. 14 is a block diagram showing a third embodiment of the present invention. In FIG. 14, the same components as in FIG. 9 are given the same reference numerals, and description thereof is omitted.

In the second embodiment, an example of storing endoscope information in a memory and reading the endoscope information into an endoscope body is shown. However, it is also possible to use a mechanical state of a jumper switch or the like to cause an endoscope to hold the endoscope information, and read the endoscope information by detecting the switch state by the endoscope body.

An endoscope 71 and an endoscope body 73 in the present embodiment are different from the endoscope 61 and the endoscope body 63 in FIG. 9 in that they are provided with a switch 72 and a memory 74 instead of the memories 62 and 64, respectively. As the switch 72, a switching device having several bits, such as a jumper switch and a dip switch, can be adopted. In the switch 72, information similar to the endoscope information stored in the memory 62 in FIG. 9, that is, endoscope information such as the type of image-pickup device (device ID), the length and diameter of an insertion portion (the length and conductor diameter of a signal line for illumination) and the type of illuminating light is stored.

For example, an endoscope ID configured by an appropriate combination of the type of image-pickup device (device ID), the length and diameter of an insertion portion (the length and conductor diameter of a signal line for illumination), the type of illuminating light and the like can be adopted as the endoscope information. In this case, it is sufficient that the switch 72 stores only the endoscope ID.

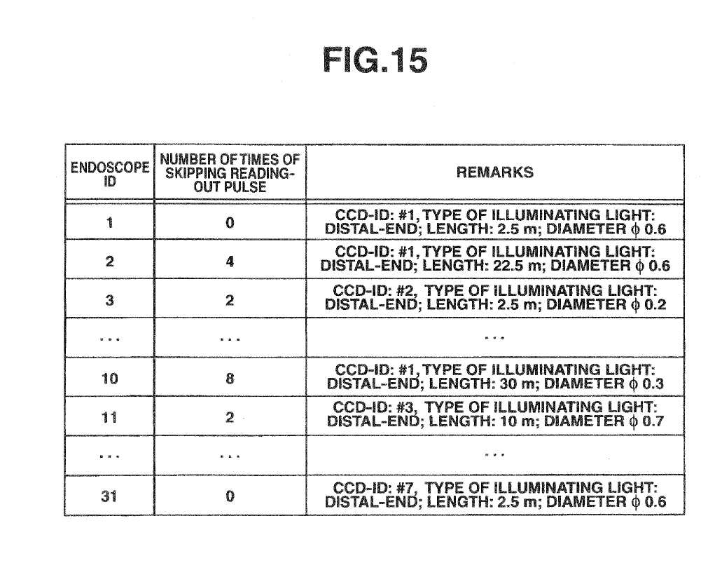

On the other hand, the memory 74 stores pattern tables similar to those in the memory 64 in FIG. 9, that is, pattern tables corresponding to the endoscope information held by the switch 72. FIG. 15 is an explanatory diagram showing an example of such a pattern table stored in the memory 74. The pattern table in FIG. 15 corresponds to a case of registering endoscope IDs with the switch 72. It shows a case where the number of skips is stored for each endoscope ID. For example, in the example in FIG. 15, it is shown that, as for an endoscope ID 3, an image pickup device with a CCD ID of #2 is adopted, and such an endoscope that the length and diameter of a signal line for illumination are 2.5 m and φ0.2 is connected with the endoscope body 73, and that, when the endoscope with the endoscope ID 3 is connected with the endoscope body 73, a control section 27 sets “twice” as the number of skips.

The control section 27 reads out the endoscope information from the switch 72, and refers to a pattern table stored in the memory 74 to acquire the number of skips corresponding to the endoscope information.

Other components, operations and advantages are similar to those of the second embodiment.

As described above, in the present embodiment also, the advantages similar to those of the second embodiment can be obtained.

### Fourth Embodiment

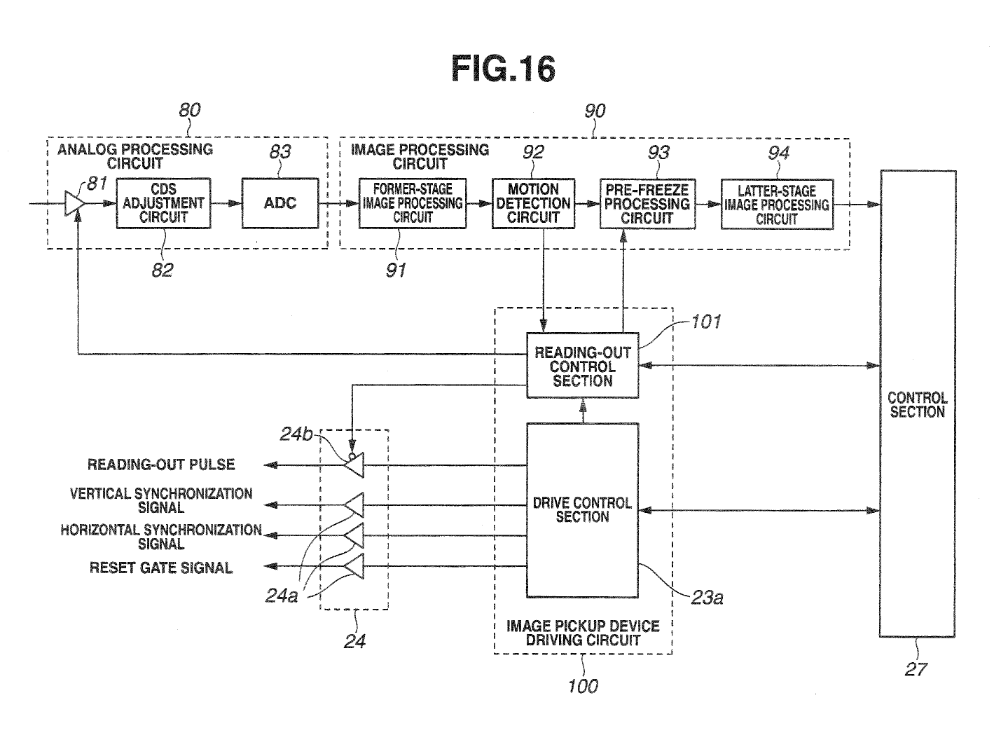

FIG. 16 is a block diagram showing a fourth embodiment of the present invention. The present embodiment is applied to the endoscope apparatuses of the first to third embodiments when they are provided with a pre-freeze processing function. FIG. 16 shows a part of components of an endoscope body, and other components are similar to those of the endoscope apparatuses in the first to third embodiments. In FIG. 16, the same components as in FIG. 1B are given the same reference numerals, and description thereof is omitted.

An analog processing circuit 80 is configured by a pre-amplifier 81, a CDS adjustment circuit 82 and an ADC 83. Gain of the pre-amplifier 81 is controlled by a reading-out control section 101 to be described later, and the pre-amplifier 81 amplifies a video signal from an image pickup device 14a and outputs the video signal to the CDS adjustment circuit 82. The CDS adjustment circuit 82 eliminates noise by CDS (correlated double sampling) processing and outputs a video signal with an improved S/N ratio. The ADC 83 converts output of the CDS adjustment circuit 82 to a digital signal and then outputs the digital signal to an image processing circuit 90.

A former-stage image processing circuit 91 of the image processing circuit 90 is given the output of the ADC 83, and the former-stage image processing circuit 91 outputs the output to a motion detection circuit 92 after performing predetermined preprocessing. The motion detection circuit 92 has a memory not shown. The motion detection circuit 92 detects the amount of motion, for example, by operation for previous and following frames, and outputs a motion detection result to a pre-freeze processing circuit 93 and the reading-out control section 101. For example, the motion detection circuit 92 may determine the motion detection result by detecting luminance differences among fields.

The pre-freeze processing circuit 93 has a memory not shown and can realize a pre-freeze mode. The pre-freeze processing circuit 93 sequentially records images from the former-stage image processing circuit 91 after start of the pre-freeze mode. When a freeze signal is inputted, the pre-freeze processing circuit 93 selects an image judged by a motion detection result to be the image with the smallest motion among images recorded during a predetermined period before and after a freeze timing (hereinafter referred to as a pre-freeze processing period) and outputs the image as a still image by pre-freeze processing.

A video signal of the still image from the pre-freeze processing circuit 93 is given to a latter-stage image processing circuit 94. The latter-stage image processing circuit 94 outputs the inputted video signal to a control section 27 after performing predetermined video signal processes, such as noise reduction and color adjustment, for the video signal. The control section 27 provides the video signal obtained by performing image processing for a display control circuit 28. Thereby, moving image display and still image display can be performed on a display device 41.

The control section 27 may switch between live display and still image display according to a user operation. The control section 27 may transition from live display to still image display in accordance with a user operation of pressing a shutter button and automatically return to live display after elapse of a predetermined time.

An image pickup device driving circuit 100 is configured by a drive control section 23a and the reading-out control section 101. The reading-out control section 101 generates a reading-out skipping control signal to a control the driver 24b as well as outputting a gain control signal for controlling gain of the pre-amplifier 81. In the present embodiment also, when a freeze signal is inputted from the control section 27, the reading-out control section 101 generates a reading-out skipping control signal for skipping generation of a reading-out pulse a specified number of times, similarly to the reading-out control section 23b. The reading-out control section 101 may continue reading out of accumulated charge while skipping generation of a reading-out pulse (hereinafter referred to as reading out with skip) until the end of a pre-freeze processing period (still image display period).

Furthermore, in the present embodiment, the reading-out control section 101 generates a reading-out skipping control signal based on a motion detection result during the pre-freeze mode period. For example, the reading-out control section 101 is adapted to be able to skip generation of a reading-out pulse a specified number of times if a motion detection result indicates being equal to or below a predetermined threshold.

For example, during the pre-freeze mode period, the reading-out control section 101 skips generation of a reading-out pulse the specified number of times even before generation of a freeze signal if a motion detection result indicates being equal to or below the predetermined threshold. Furthermore, during the pre-freeze processing period, the reading-out control section 101 may perform reading-out pulse skipping control not only with generation of a freeze signal as a trigger but also based on a motion detection result.

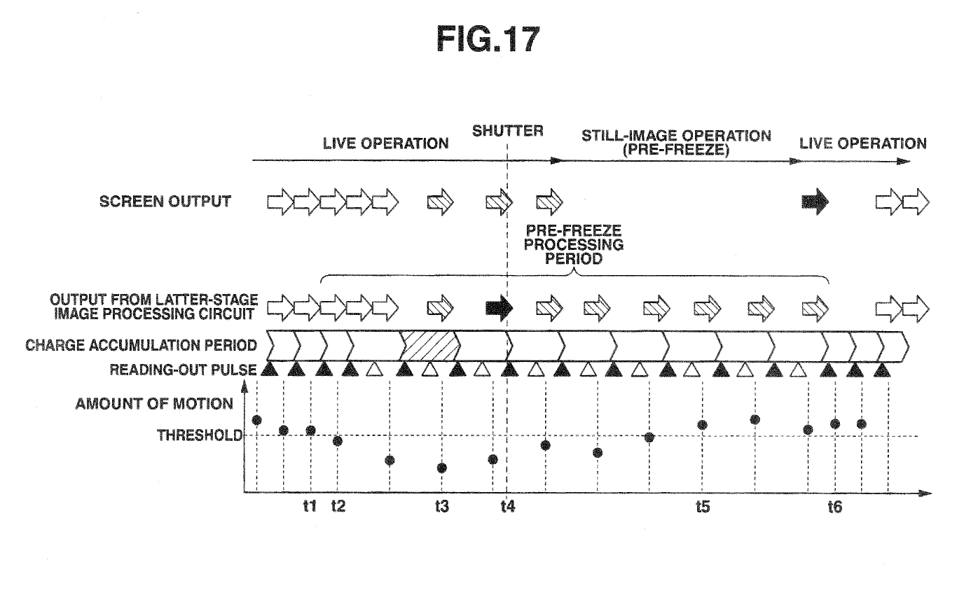

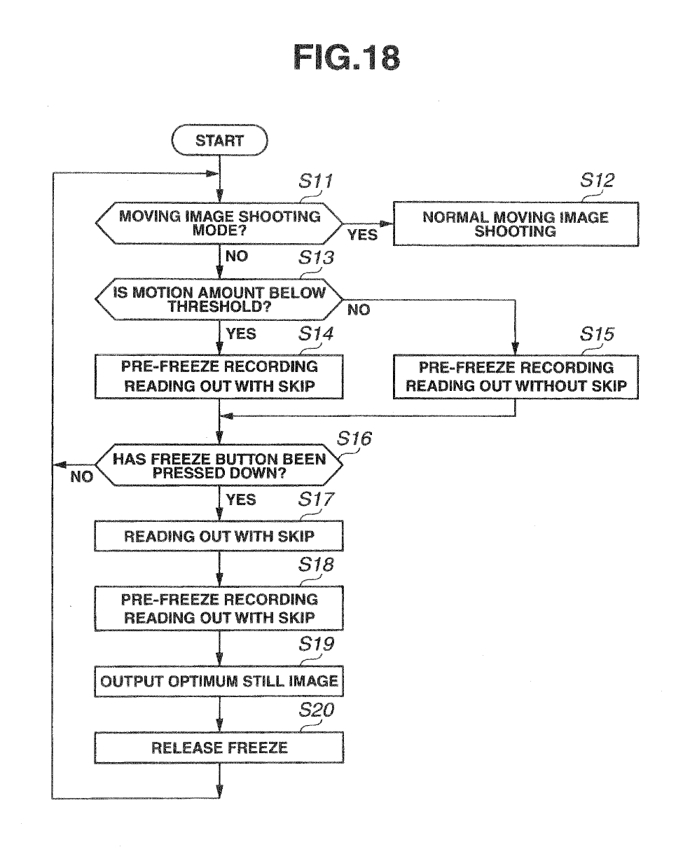

Next, operations of the embodiment configured as described above will be described with reference to FIGS. 17 and 18. FIG. 17 is an explanatory diagram for illustrating an operation of the pre-freeze processing in the fourth embodiment, and FIG. 18 is a flowchart for illustrating an operation of the fourth embodiment. FIG. 17 shows screen outputs, outputs of the latter-stage image processing circuit 94, charge accumulation periods, reading-out pulses and the amount of motion of an image in each charge accumulation period. In FIG. 17, a filled triangle mark indicates a generated reading-out pulse and a white triangle mark indicates an omitted (skipped) reading-out pulse. An arrow indicates image output obtained in each charge accumulation period, a white arrow indicates image output by normal reading out (hereinafter referred to as reading out without skip) in which a reading-out pulse is not skipped, an arrow with oblique-line hatching indicates image output read out with skip, and a filled arrow indicates output of an image selected in the pre-freeze processing.

As shown in FIG. 17, in a period during which a reading-out pulse is skipped, the charge accumulation period is extended. FIG. 17 shows an example in which, at the time of reading out with skip, a reading-out pulse is generated every other time, and the charge accumulation period is extended twice as long as that at normal time. As described above, the number of times of skipping a reading-out pulse is set, for example, based on endoscope information and the like.

At step S11 in FIG. 18, the control section 27 judges whether the moving image shooting mode is specified or not. If the moving image shooting mode is specified, the control section 27 controls each section so that normal moving image shooting is performed (step S12). In the example in FIG. 18, the control section 27 is adapted to transition to the pre-freeze mode if the moving image shooting mode is not specified.

In the present embodiment, in the pre-freeze mode, a motion detection result (the amount of motion) from the motion detection circuit 92 is provided for the reading-out control section 101 (step S13). The reading-out control section 101 judges whether the motion detection result (the amount of motion) is equal to or below a predetermined threshold (step S13). If judging that the amount of motion is equal to or below the predetermined threshold, that is, the motion is small, the reading-out control section 101 performs reading-out pulse skipping control to extend a charge accumulation period and improves the image quality of a video signal obtained from the image pickup device 14a (step S14). If the amount of motion is larger than the threshold, the reading-out control section 101 performs reading out without skip, without performing the reading-out pulse skipping control.

In the example in FIG. 17, if the level of a black circle indicating the amount of motion is equal to or below the threshold, the reading-out control section 101 skips a reading-out pulse. In FIG. 17, the amount of motion of picked-up images at and before a timing t1 is larger than the threshold, and reading out without skip is performed. The amount of motion is smaller than the threshold at and after a timing t2, and reading out with skip is performed.

By reading out with skip being performed, the charge accumulation period is longer by a length corresponding to the number of times of skipping a reading-out pulse, and the image quality is higher. Pre-freeze recording of steps S14 and S15 is repeated until an operation of pressing down the shutter button (freeze button) is performed at step S16.

Here, it is assumed that a still image shutter button is operated at a timing t4 indicated by a broken line in FIG. 17. Thereby, a freeze signal is generated from the control section 27. The pre-freeze processing circuit 93 is configured, for example, so as to record four still images before generation of a freeze signal and record six still images after generation of the freeze signal. That is, in the example in FIG. 17, images after an image picked up at the timing t2 are recorded to the pre-freeze processing circuit 93.

When a freeze signal is generated, the reading-out control section 101 controls a driver 24b by a reading-out skipping control signal to perform reading-out pulse skipping control a specified number of times. Thereby, images picked up after the timing t4 are read out with skip (step S17). In the example in FIG. 17, since the amount of motion is equal to or below the threshold, reading out with skip is performed before generation of the freeze signal. The period of reading out with skip can be appropriately set. For example, as in the example in FIG. 17, the reading-out control section 101 may perform reading out with skip until the end of a pre-freeze processing period after generation of a freeze signal and then return to normal reading out without skip.

The pre-freeze processing circuit 93 is controlled by the reading-out control section 101 to, when a freeze signal is generated, record six still images after the freeze timing t4 (step S18). In the example in FIG. 17, a total of ten still images are recorded during a pre-freeze processing period. The pre-freeze processing circuit 93 selects a still image with the smallest amount of motion from among still images stored during the pre-freeze processing period and outputs the still image (step S19). In the example in FIG. 17, it is shown that the amount of motion at the timing t3 is the smallest, and a still image (a filled arrow) based on charge accumulated during a charge accumulation period (a shaded portion) corresponding to the timing t3 is selected. The selected still image is screen-outputted at the end of the pre-freeze processing period.

When freeze processing is released at step S20, the reading out returns to normal reading out without skip (timing t6).

As described above, in the present embodiment also, when a freeze signal is inputted, generation of a reading-out pulse is skipped the number of time of skips based on endoscope information or the like during a specified period after a freeze timing. Thereby, it is possible to improve the image quality of a still image to be picked up. Furthermore, in the present embodiment, since reading-out pulse skipping control based on the amount of motion is performed in the pre-freeze mode, it is possible to, even in the case of acquiring a still image before generation of a freeze signal in the pre-freeze processing, improve the image quality of the still image to be acquired.

In the case of controlling generation of a reading-out pulse by a freeze signal, generation of a reading-out pulse is continuously skipped the number of skips based on endoscope information or the like during a predetermined period after generation of the freeze signal. However, if a motion detection result indicates being higher than a predetermined threshold during a predetermined period after the generation of the freeze signal, the reading-out pulse skipping control may be stopped.

For example, the amount of motion is higher than the threshold after a timing t5 in FIG. 17. In this case, the reading-out control section 101 may perform reading out without skip after the timing t5 even during the pre-freeze processing period.

In the present embodiment, application to the pre-freeze mode has been described. However, application to a freeze mode is also possible in which video signals are sequentially recorded during a predetermined period after a freeze timing, and an image judged by a motion detection result to be the image with the smallest among the stored still images is selected.

In each of the above embodiments, it is shown that processing time during a dummy processing period is the same as processing time during a video signal processing period. However, it is also possible to, at the time of skipping a reading-out pulse, perform a high-speed discarding operation of omitting a part of accesses during dummy time to shortening access time.

The high-image-quality live display described above can be applied to a measurement mode. In an endoscope, a measurement target may be set by referring to live display in the measurement mode. In this case, it is possible to, when a user operation for specifying a measurement pointer setting mode is performed, transition to the high-image-quality live mode so that the user can accurately set a measurement point and perform normal live display operation in other modes.

At the time of still image display in the live operation mode, a so-called multi-image pickup processing may be performed in which multiple still images are picked up, and an optimum still image is generated from the multiple picked-up images. In the multi-image pickup processing, it is possible to generate an optimum still image with a high image quality by setting the number of times of skipping a reading-out pulse for each of multiple images at the time of multi-image pickup and repeating the setting for all of the multiple picked-up images.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. An endoscope apparatus comprising:
an endoscope body comprising an image processing circuit for processing a video signal outputted from an image pickup device provided at a distal end portion of an insertion portion;
an image pickup device driving circuit provided for the endoscope body and providing a drive signal to the image pickup device via the insertion portion; and
a control section having a first display form for displaying an endoscope image based on the video signal and a second display form for displaying an endoscope image with an image quality different from that of the first display form, and controlling the image pickup device driving circuit to skip reading out in units of one field or one frame of the image pickup device to change a charge accumulation period, accompanying an operation of switching to the second display form during display in the first display form.

2. The endoscope apparatus according to claim 1, comprising:
an endoscope;
a first memory provided for the endoscope and storing endoscope information about the endoscope; and
a second memory provided for the endoscope body and storing a pattern table for determining the charge accumulation period corresponding to the endoscope information; wherein
when changing the charge accumulation period, the control section reads out the endoscope information from the first memory and refers to the pattern table stored in the second memory to determine the charge accumulation period.

3. The endoscope apparatus according to claim 1, comprising:
an endoscope;
a switch provided for the endoscope and storing endoscope information about the endoscope; and
a second memory provided for the endoscope body and storing a pattern table for determining the charge accumulation period corresponding to the endoscope information; wherein
when changing the charge accumulation period, the control section reads out the endoscope information from the switch and refers to the pattern table stored in the second memory to determine the charge accumulation period.

4. The endoscope apparatus according to claim 2, wherein the endoscope information includes at least one piece of information among a type of the image pickup device, a type of illuminating light for illuminating an object, line length and diameter of a signal line for obtaining the illuminating light, and length and diameter of a transmission line for transmitting the illuminating light.

5. The endoscope apparatus according to claim 3, wherein the endoscope information includes at least one piece of information among a type of the image pickup device, a type of illuminating light for illuminating an object, line length and diameter of a signal line for obtaining the illuminating light, and length and diameter of a transmission line for transmitting the illuminating light.

6. The endoscope apparatus according to claim 2, wherein the endoscope information is ID information identifying the endoscope.

7. The endoscope apparatus according to claim 3, wherein the endoscope information is ID information identifying the endoscope.

8. The endoscope apparatus according to claim 1, wherein the image pickup device driving circuit changes the charge accumulation period by skipping pulse generation of a reading-out pulse controlling reading out from the image pickup device.

9. The endoscope apparatus according to claim 2, wherein the image pickup device driving circuit changes the charge accumulation period by skipping pulse generation of a reading-out pulse controlling reading out from the image pickup device.

10. The endoscope apparatus according to claim 3, wherein the image pickup device driving circuit changes the charge accumulation period by skipping pulse generation of a reading-out pulse controlling reading out from the image pickup device.

11. The endoscope apparatus according to claim 8, wherein the control section controls the charge accumulation period by controlling the number of times of skipping the pulse generation of the reading-out pulse.

12. The endoscope apparatus according to claim 9, wherein the control section controls the charge accumulation period by controlling the number of times of skipping the pulse generation of the reading-out pulse.

13. The endoscope apparatus according to claim 10, wherein the control section controls the charge accumulation period by controlling the number of times of skipping the pulse generation of the reading-out pulse.

14. The endoscope apparatus according to claim 2, wherein
the image pickup device driving circuit changes the charge accumulation period by skipping pulse generation of a reading-out pulse controlling reading out from the image pickup device; and
the pattern table has information about the number of times of skipping based on the endoscope information.

15. The endoscope apparatus according to claim 3, wherein
the image pickup device driving circuit changes the charge accumulation period by skipping pulse generation of a reading-out pulse controlling reading out from the image pickup device; and
the pattern table has information about the number of times of skipping based on the endoscope information.

16. The endoscope apparatus according to claim 1, wherein the control section changes the charge accumulation period in response to an operation of switching between live display and still image display in a live operation mode or an operation of switching between the live display and high-image-quality live display in the live operation mode.

17. The endoscope apparatus according to claim 8, wherein the control section changes the charge accumulation period in response to an operation of switching between live display and still image display in a live operation mode or an operation of switching between the live display and high-image-quality live display in the live operation mode.

18. The endoscope apparatus according to claim 1, wherein the control section skips reading out in units of one field or one frame of the image pickup device if motion of the endoscope image is smaller than a predetermined threshold even during display in the first display form.

19. The endoscope apparatus according to claim 18, wherein the control section skips reading out in units of one field or one frame of the image pickup device if the motion of the endoscope image is smaller than the predetermined threshold at a time of pre-freeze processing.

20. The endoscope apparatus according to claim 19, wherein the control section does not skip reading out in units of one field or one frame of the image pickup device if the motion of the endoscope image is larger than the predetermined threshold at the time of the pre-freeze processing even during display in the second display form.
